(19) United States
(12) Patent Application Publication
(10) Pub. No.: US 2009/0187540 A1
(43) Pub. Date: Jul. 23, 2009

(54) PREDICTION OF INFORMATIONAL INTERESTS

(75) Inventors: Matthew Richardson, Seattle, WA (US); Lilyana Simeonova Mihalkova, Austin, TX (US); Robert L. Rounthwaite, Fall City, WA (US); Mikhail Bilenko, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/017,346

(22) Filed: Jan. 22, 2008

(51) Int. Cl. G06F 17/30

(52) U.S. Cl. 707/3; 707/E17.108

(57) ABSTRACT

Described herein is a system that includes a receiver component that receives an indication that a user has accessed a search engine to initiate a search session. An analyzer component predicts informational interests of the user upon receipt of the indication and outputs an informational item that corresponds to the predicted informational interests of the user, wherein the analyzer component is configured to output the informational item prior to the user issuing a query to the search engine.

### BACKGROUND

Search engines have enabled users to quickly access information over the Internet. Specifically, a user can issue a query to a search engine and peruse ranked results returned by the search engine. For example, a user can provide a search engine with the query “Spider” and be provided with web pages relating to various arachnids, web pages relating to automobiles, web pages relating to films, web pages related to web crawlers, and other web pages. Search engines may also be used to return images to an issuer of a query, academic papers, videos, and other information.

While sophistication of search engines has increased, users still often have difficulty locating desired information. For example, users have to construct queries that can be used by the search engine to locate information desired by the user, wherein the query may not be optimally crafted to locate desired information. If the user constructs a suboptimal query, the user may be required to search through multiple pages of results prior to locating the desired information. Often, if the desired information is not among the first several search results listed (e.g., search results on a first page), the user will either submit another query or entirely give up on locating the information.

If the user experiences angst in locating desired information, the user may cease using the search engine as a primary search engine. For instance, the user may perceive that the search engine that was used to locate information is at fault for not providing the desired information on a first page of search results. The user may then begin primarily using a different search engine for information retrieval needs. As users drive the revenue stream for search engines, it is imperative that search engines keep their users “happy.” In other words, search engines must continuously compete with other search engines to better suit informational needs of users thereof, or risk the loss of customers to other search engines who better meet informational needs of the user.

### SUMMARY

The following is a brief summary of subject matter that is described in greater detail herein. This summary is not intended to be limiting as to the scope of the claims.

Various technologies relating to predicting informational items (such as queries) that will be of interest to the user prior to the user initiating a search session with a search engine are described herein. Upon receipt of an indication that a user desires to initiate a search with a search engine, one or more informational items that are predicted to be of interest to the user can be presented to the user. The informational items can be presented prior to the user issuing a query or placing any text into a query field. A machine-learned model can be used to output informational items that are predicted to be of interest to the user. For instance, the machine-learned model can be or include a relational model, such as a Markov Logic Network, and/or may be or include a propositional model, such as a Bayesian network, a support vector machine, a decision tree, naive Bayes, or neural network.

Pursuant to an example, historical data of other users can be used to predict informational items that will be of interest to the user. Thus, for instance, if the general population finds a certain query interesting, it may be inferred that the user will find the certain query interesting. In another example, historical data of the user can be used to predict informational items that will be of interest to the user. Thus, if a user consistently performs searches with a particular query, it may be inferred that the user will find the particular query interesting. In yet another example, historical data of users found to be similar to the user can be used to predict informational items that will be interesting to the user.

Informational items that are predicted to be of interest to the user can be presented to the user in any suitable format. For example, the informational items can be presented in the form of a selectable hyperlink, wherein selection of the hyperlink causes a search to be performed using the selected query. In another example, selection of a presented hyperlink may cause a website corresponding to the hyperlink to be presented to a user. The aforementioned informational items can be presented on a search engine home page, on an email application, on a web page with an interface to a search engine, or in any other suitable location.

Other aspects will be appreciated upon reading and understanding the attached figures and description.

### BRIEF DESCRIPTION OF THE DRAWINGS

FIG. 1 is a functional block diagram of an example system that facilitates outputting an informational item that is predicted to be of interest to a user.

FIG. 2 is a functional block diagram of an example system that facilitates displaying an informational item that is predicted to be of interest to a user.

FIG. 3 is a functional block diagram of an example system that facilitates determining an informational item that is predicted to be of interest to a user.

FIG. 4 is a functional block diagram of an example system that facilitates outputting a query suggestion.

FIG. 5 is a functional block diagram of an example system that facilitates training a component that outputs informational items that are predicted to be of interest to a user.

FIG. 6 is a functional block diagram of an example system that facilitates displaying an informational item that is predicted to be of interest to a user.

FIG. 7 is a flow diagram that illustrates an example methodology for displaying an informational item to a user, wherein the informational item corresponds to predicted informational interests of the user.

FIG. 8 is a flow diagram that illustrates an example methodology for displaying a query to a user.

FIG. 9 is a flow diagram that illustrates an example methodology for outputting an informational item.

FIG. 10 is an example graphical user interface.

FIG. 11 is an example graphical user interface.

FIG. 12 is an example graphical user interface.

FIG. 13 is an example computing system.

### DETAILED DESCRIPTION

Various technologies pertaining to predicting queries that will be of interest to a user will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

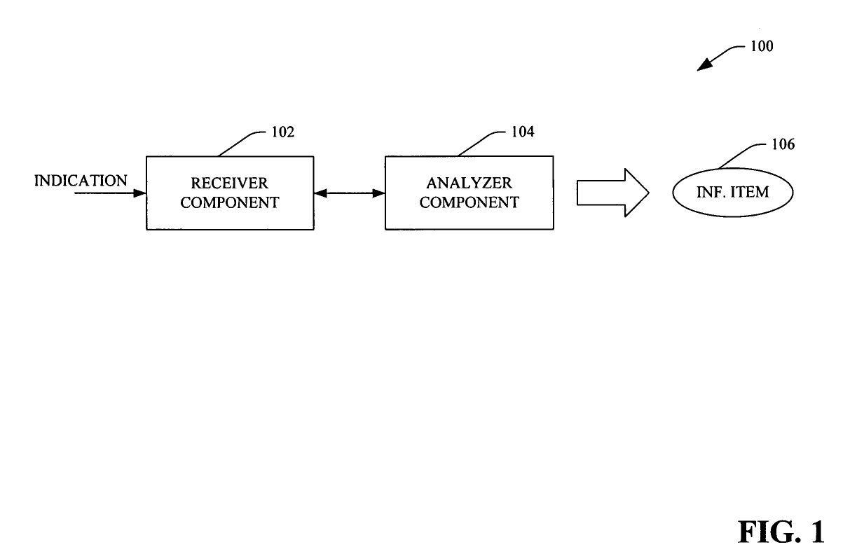

With reference to FIG. 1, an example system 100 that facilitates predicting informational interests of a user is illustrated. The system 100 includes a receiver component 102 that receives an indication that a user has requested access to a search engine to initiate a search session. An analyzer component 104 is in communication with the receiver component 102. In one example, the analyzer component 104 predicts informational interests of the user (e.g., specific to the user) upon receipt of the indication and outputs at least one informational item 106 that corresponds to the predicted informational interests of the user. For instance, the informational item may be a query, a hyperlink, an informational category, news information, a suitable combination thereof, etc. The analyzer component 104 is configured to output the informational item 106 prior to the user issuing a query to the search engine. Informational interests can refer to one or more ranges of information that a user is interested in. For example, automobiles may be an informational interest, as well as automobile repair, automobile sales, or other subsets. Accordingly, there exists an infinite number of possible informational interests. In another example, the analyzer component 104 can predict informational itemss that the user will find interesting. For example, based upon previous queries and features relating thereto, the analyzer component 104 can predict informational items that the user is likely to find interesting.

Pursuant to an example, the indication received by the receiver component 102 may be that the user has entered a Uniform Resource Locator of a search engine into a browser. In another example, the indication may be that the user has selected a hyperlink that will direct the user to a search engine. In yet another example, the indication may be opening a browser, wherein the homepage of the user is the search engine. Furthermore, an email application may include a query field that enables access to a search engine, and the indication that the user has requested access to the search engine may be initiating the email application. Similarly, a web page (such as a web page related to news coverage) may include a field where queries can be entered, and the indication may be the user requesting access to the web page. The search engine may be an Internet search engine, a search engine that searches consumer-level computers for information (e.g., a desktop search engine), a search tool that is configured to search databases, and/or the like. Other example indications of requests to initiate a search session are contemplated and intended to fall under the scope of the hereto-appended claims.

The analyzer component 104 may be or include a machine-learned model that is trained to predict informational interests of users. Pursuant to an example, the analyzer component 104 can include a relational machine-learned model. In another example, the analyzer component 104 may be or include a Bayesian model, an artificial neural network, a logistic regression model, a support vector machine, a decision tree, naive Bayes, or any other suitable machine-learning model or network. The analyzer component 104 may be trained using historical data that includes user interaction with respect to search engines, such as queries issued by users, search results corresponding to the queries, query suggestions provided in response to the queries, search results selected by users, advertisements selected by users, webpages viewed by users, and/or other suitable data. In an example, a toolbar may be used to collect data such as the types listed above, and the collected data may be used to train the analyzer component 104. Any suitable manner for training the analyzer component 104 such that, when trained, the analyzer component 104 can predict informational interests of users is contemplated and intended to fall under the scope of the hereto-appended claims.

Furthermore, the analyzer component 104 may be trained with contextual data to facilitate more accurate prediction of informational interests of users. For example, informational interests may at least partially depend upon current weather conditions, time of day, day of week, current news events, predicted weather conditions, and/or the like. Thus, the analyzer component 104 can generate predictions of present informational interests of the user as well as generate predictions of future informational interests of the user. Still further, the analyzer component 104 can predict future informational interests of the user based upon current predicted informational interests of the user. In other words, the analyzer component 104 can make inferences upon inferences when generating predictions of informational interests.

To facilitate understanding, a specific example is provided herein to illustrate functionality of the system 100. It is understood that this example is not intended to be limiting as to the scope of the claims. A user can enter a URL of a search engine into a browser, wherein the entrance of the URL is an indication that the user wishes to initiate a search session using the search engine. The receiver component 102 receives the indication. The analyzer component 104 may then receive the indication from the receiver component 102, and based upon historical data (e.g., of the user and/or other users), current data (e.g., current news events, current search trends, . . . ) and contextual data (such as time of day, day of week, weather conditions, etc.) the analyzer component 104 can predict informational interests of the user. Pursuant to an example, based upon the historical data, current data and contextual data the analyzer component 104 may predict that the user is interested in purchasing a home. The analyzer component 104 may then output the informational item 106, wherein the informational item is configured to aid the user in reviewing/locating information pertaining to purchasing a home. For example, the analyzer component 104 can output a query that, if executed, would return information pertaining to houses for sale in a geographic region of the user. For instance, the output informational item 106 may be saved in a computer-readable medium and/or displayed to the user.

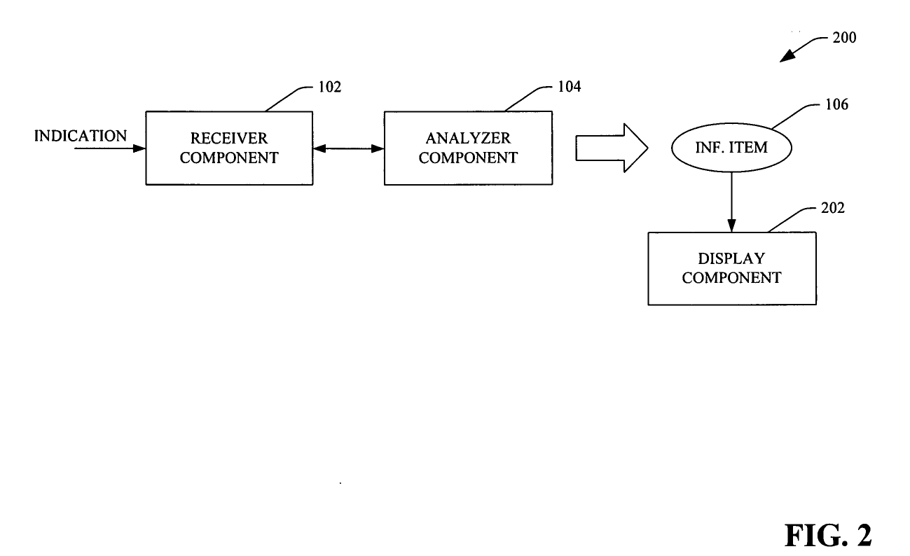

Now referring to FIG. 2, an example system 200 that facilitates displaying informational items to users is illustrated. The system 200 includes the receiver component 102 and the analyzer component 104, which operate in conjunction as described above. The system 200 further includes a display component 202 that displays the informational item 106 to the user. In an example, the display component 202 can display the informational item 106 to the user prior to the user issuing a query to the search engine. In another example, the analyzer component 104 can output multiple informational items, and the display component 202 can display the multiple informational items to the user prior to the user issuing a query to the search engine. In still yet another example, the analyzer component 104 can assign values to the informational items that indicate a level of interest the user will have with respect to the informational items. The display component 202 may then display the informational items in an order that corresponds to the assigned values.

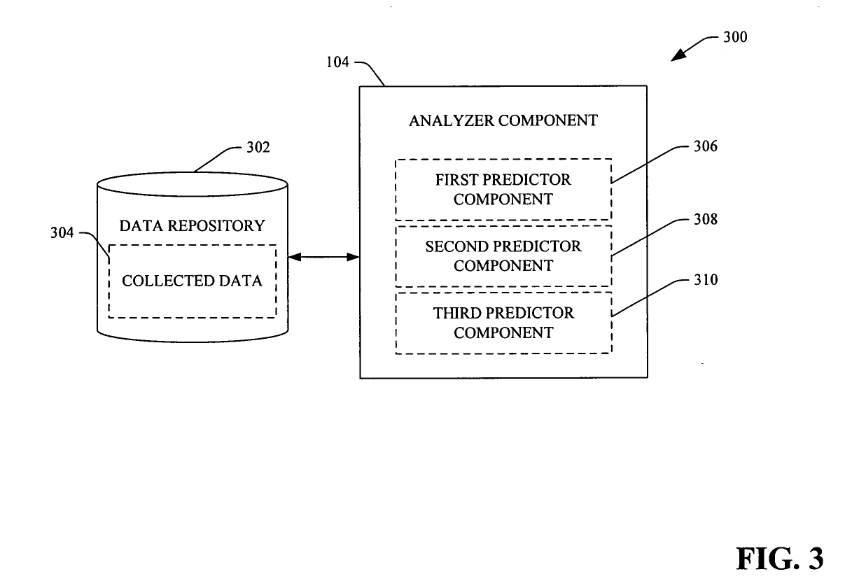

Turning now to FIG. 3, an example system 300 that facilitates predicting informational interests of users is illustrated. The system includes a data repository 302, wherein the data repository 302 includes collected data 304. The collected data 304 may include queries issued by users, web pages visited by users, search results corresponding to queries, contextual information corresponding to user interaction with queries, current news events, recent searches, most common searches of all users over a recent threshold amount of time for a subset of all users, and other suitable information.

The analyzer component 104 may be or include a machine-learned model that is trained using the collected data 304. In another example, the analyzer component 104 can access the collected data 304 each time an indication is received that the user desires to initiate a search session with a search engine, and can predict informational interests of the user based upon an analysis of the collected data 304. In still yet another example, the analyzer component 304 may execute as a low priority thread and can analyze the collected data 304 as a background task. Accordingly, the analyzer component 304 can predict informational interests of the user prior to the user initiating a search session with a search engine.

The analyzer component 104 may, for example, include three different predictor components, which may be or include any suitable machine-learned model that can predict informational interests of one or more users. Specifically, the analyzer component 104 can include a first predictor component 306, a second predictor component 308, and a third predictor component 310. The first predictor component 306 uses historical data of a plurality of users to predict the informational interests of the user. More particularly, the first predictor component 306 can leverage data with respect to other uses (both users found to be similar to the user and users that are not similar to the user) to generate predictions of informational interests. The second predictor component 308 uses historical data of the user to predict the informational interests of the user. In particular, the second predictor component 308 can leverage previous actions of the user (e.g., on the Internet) to predict current or future informational interests of the user. The third predictor component 310 uses historical data of a plurality of users that are determined to be similar to the user to predict informational interests of the user. For instance, users can be profiled, and historical data of users that have a substantially similar profile when compared to a profile of the user can be used by the third predictor component 310 to predict informational interests of the user.

The analyzer component 104 can use any combination of the predictor components 306-310 to predict the informational interests of the user. Moreover, the predictor components 306-310 can operate in any sequence or can operate in parallel. Thus, for example, the first predictor component 306 and the third predictor component 310 may operate in parallel and output predictions of informational interests and such predictions may be combined. In another example, the third predictor component 310 may output predictions of informational interests and the first predictor component 306 may thereafter output predictions of informational interests. Again, such predictions may be combined.

As noted above, the analysis component 104 can leverage historical data of the user alone or may use data from other users to predict informational interests of the user. For example, the first predictor component 306 can find that historically, users who search for mortgages will search for furniture about a month later. The first predictor component 306 can determine that the user searched for mortgage information a month ago and predict that the user will search for furniture now, even though the user may have never searched for furniture in the past. In another example, users that have similar search histories to a certain user can be located, and when the users begin searching for a particular term, the third predictor component 310 can predict that the certain user will also wish to search for the particular term.

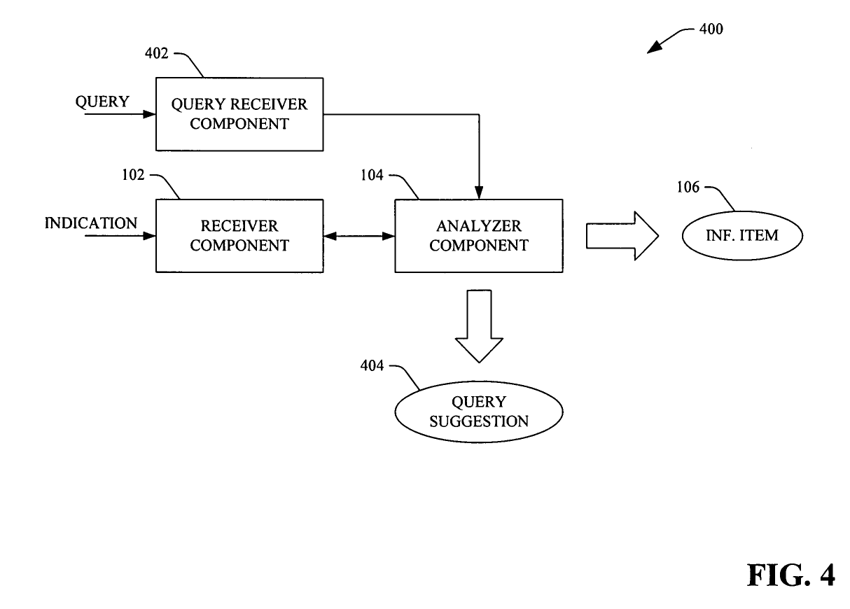

With reference now to FIG. 4, an example system 400 that facilitates generation of queries and query suggestions is illustrated. The system 400 includes the receiver component 102 and the analyzer component 104, which act in conjunction as described above to output the query 106. In an example, the query 106 can be displayed to the user prior to the user executing a query. The system 400 can further include a query receiver component 402 that receives a query that has been issued by the user. The query may be the query 106 output by the analyzer component 104 or can be a query that is entered into a search field by the user.

The analyzer component 104 is in communication with the query receiver component 402, and can receive the query from the query receiver component 402. The analyzer component 402 may also receive data pertaining to the query, such as where the query originated (the geographic location of the user), time of day, day of week, weather conditions, user identity, search results pertaining to the query, and/or other data that may pertain to the data. Based at least in part upon such information, the analyzer component 104 can output a query suggestion 404. The query suggestion may be a query that the user will find of interest and may be based at least in part upon the query issued by the user. In an example, the query suggestion 404 can be displayed to a user as a selectable hyperlink together with search results pertaining to the query issued by the user. In another example, the analyzer component 104 can output a plurality of query suggestions 404 that can be displayed to the user.

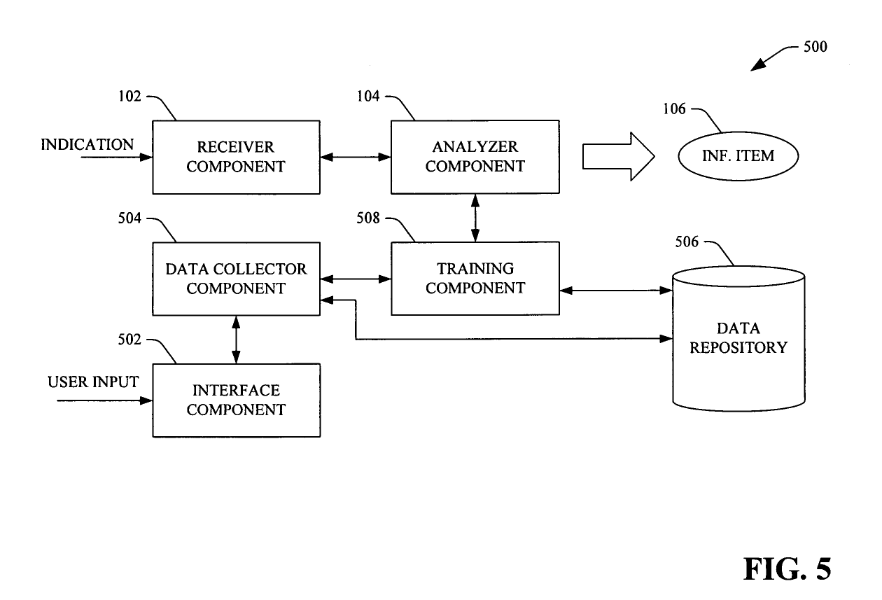

Now referring to FIG. 5, an example system 500 that facilitates training the analyzer component 104 is illustrated. The system 500 includes the receiver component 102 and the analyzer component 104, which act in conjunction (as described above) to output the query 106. The system 500 additionally includes an interface component 502 that is configured to receive user input. The user input may be selection of a hyperlink, typing of a URL into a browser, entrance of a query into a search engine, and/or other suitable user input. A data collector component 504 is in communication with the interface component 502 and collects data pertaining to the user input. Such data can include queries, content of pages visited, search results corresponding to queries, query suggestions provided in response to queries, query suggestions selected, data pertaining to the user, such as user identification, user location, contextual information such as time of day, day of week, and/or the like that corresponds to the user input, and any other suitable data that pertains to the interface component 502. For example, the data collector component 504 may be in communication with a data repository that includes search results, one or more sensors that can indicate to the data collector component 504 the time of day or other contextual information, etc.

The system 500 additionally includes a data repository 506 that is used to retain the data collected by the data collector component 504. A training component 508 can use the data collected by the data collector component 504 (e.g., data currently collected and data collected in the past) to train the analyzer component 104. For example, the training component 508 can detect patterns in data collected by the data collector component 504 and can train the analyzer component 104 based at least in part upon the collected patterns. The training component 508 can use any suitable machine-learning technique to train the analyzer component 104. For instance, the training component 508 can use relational machine learning techniques to train the analyzer component 104. As more data is collected by the data collector component 504, the analyzer component 104 can output improved predictions of informational interests of user, and thus output improved queries.

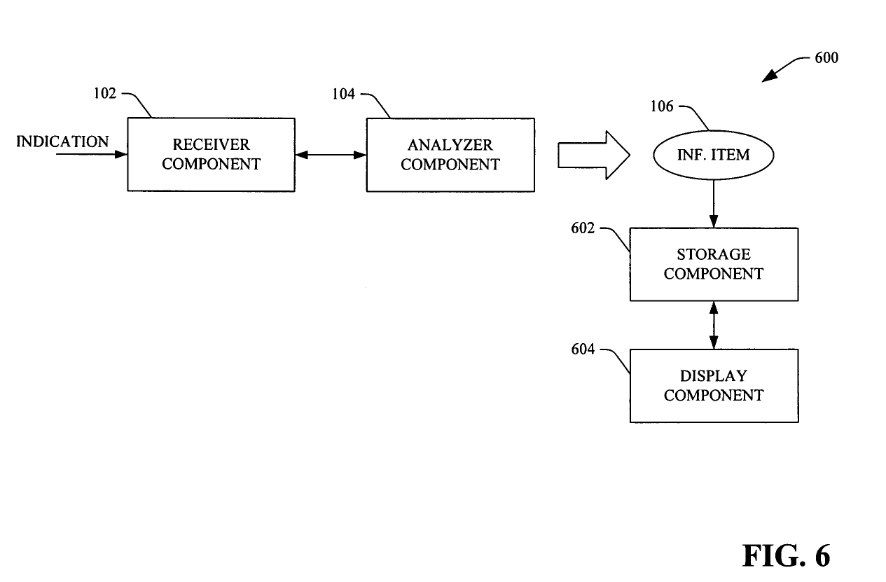

With reference to FIG. 6, an example system 600 that facilitates predicting informational interests of users is illustrated. The system 600 includes the receiver component 102 and the analyzer component 104, which operate together to output the query 106. In an example, the query 106 may relate to an informational interest of the user that will happen in the future. For example, the analyzer component 104 can determine that the user recently searched for mortgages, and further determine that users that search for mortgages are typically interested in furniture a month after they have searched for mortgages. Therefore, the query 106 can be reflective of an informational interest of the user that will occur in the future. A storage component 602 can be used to retain the query 106 until a time in the future that corresponds to the predicted informational interest. Continuing with the above example, the storage component 602 can retain the query 106 for a month. A display component 604 can display the query 106 to the user at the appropriate time.

Other manners for using temporal data are also contemplated. For instance, rather than retaining the query 106, the analyzer component 104 can be configured to predict present informational interests. For instance, the analyzer component 104 may review collected data and determine that the user was searching for mortgages a month ago, and therefore searching for furniture is a current informational interest. As can be discerned from these examples, the analyzer component 104 can use temporal information when predicting informational interests of users (and outputting queries corresponding to the informational interests).

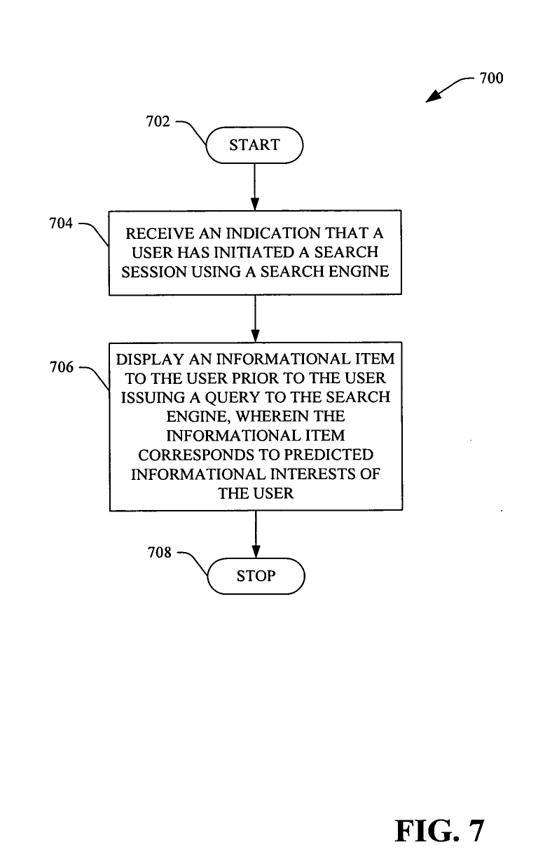

With reference now to FIGS. 7-9, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like.

Referring specifically to FIG. 7, an example methodology 700 for displaying an informational item to a user is illustrated. The methodology 700 starts at 702, and at 704 an indication that a user has initiated a search session using a search engine is received. At 704, an informational item is displayed to the user prior to the user issuing a query to the search engine, wherein the informational item corresponds to predicted informational interests of the user. For instance, the informational item may be a query can be displayed as a selectable hyperlink. The methodology 700 completes at 708.

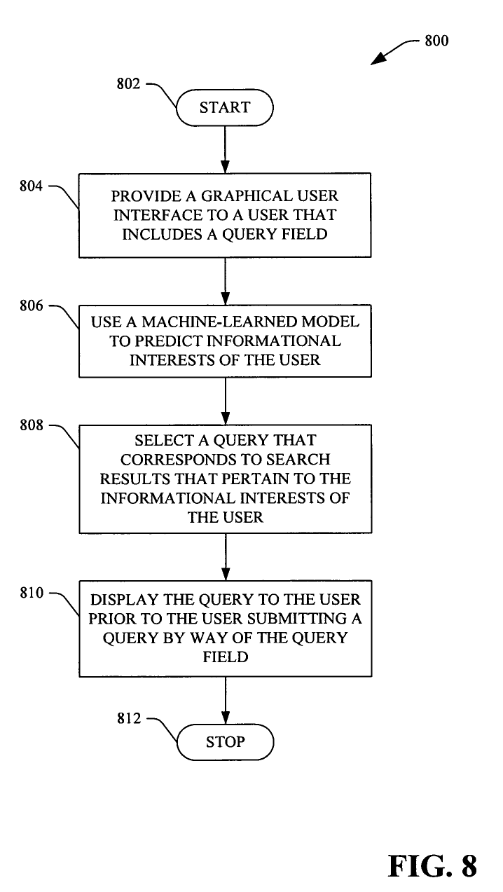

With reference now to FIG. 8, an example methodology 800 for displaying a query to a user is illustrated. The methodology 800 starts at 802, and at 804 a graphical user interface is provided to a user, wherein the graphical user interface includes a query field. More specifically, the query field is configured to receive a query from a user. At 806, a machine-learned model is used to predict informational interests of the user. For instance, the machine-learned model can or include be a Markov Logic Network, probabilistic relational model, a BLOG relational model, a structural logistic regression relational model, a relational dependency network, a probabilistic entity relationship model, or other suitable relational model. In another example, the machine-learned model can be or include a propositional model, such as a Bayesian network, a support vector machine, a decision tree, naive Bayes, neural network, or any other suitable machine-learning model.

At 808, a query that corresponds to search results that pertain to information interests of the user is selected. In an example, the selected query is a query that has not before been issued by the user. At 810, the query is displayed to the user prior to the user submitting a query by way of the query field. The methodology 800 completes at 812.

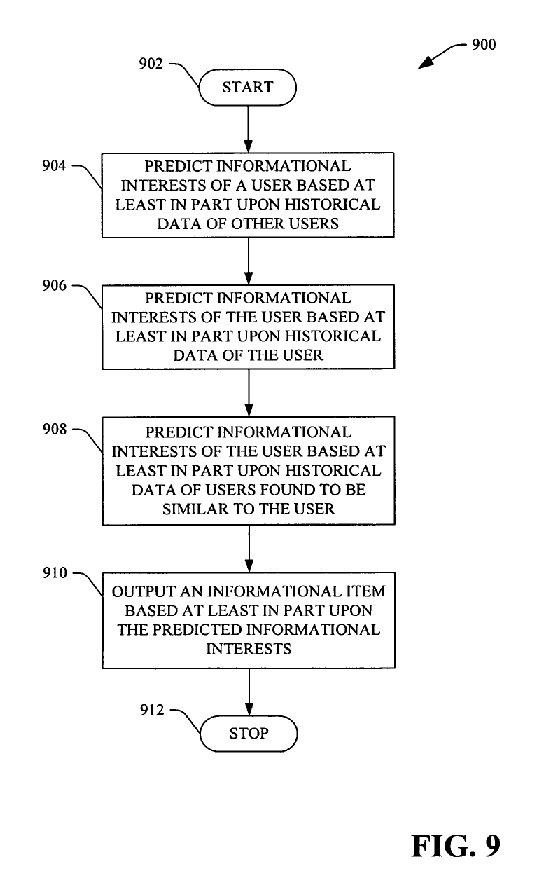

Now referring to FIG. 9, a methodology 900 that facilitates outputting an informational item to a user is illustrated. The methodology 900 starts at 902, and at 904, informational interests of the user are predicted based at least in part upon historical data of other users. For instance, the user may search for mortgages a month in the past. Other users may have searched for furniture a month after searching for mortgages. Accordingly, based on data of other users, the user may have informational interest in furniture.

At 906, informational interests of the user are predicted based at least in part upon historical data of the user. For example, if the user searches for traffic every day at 4:30 PM, it is likely that the user will have an informational interest in traffic at or around 4:30 PM. At 908, informational interests of the user are predicted based at least in part upon historical data of users found to be similar to the user. For instance, the user can be profiled based upon user history, demographic information, and/or the like, and informational interests of the user can be predicted based at least in part upon information found to be of interest to other users that are in the same or a substantially similar profile. As noted above, order of these acts may be altered or occur in parallel.

At 910, an informational item is output based at least in part upon the predicted informational interests. In another example, multiple queries can be output based at least in part upon the predicted informational interests. The methodology 900 completes at 912.

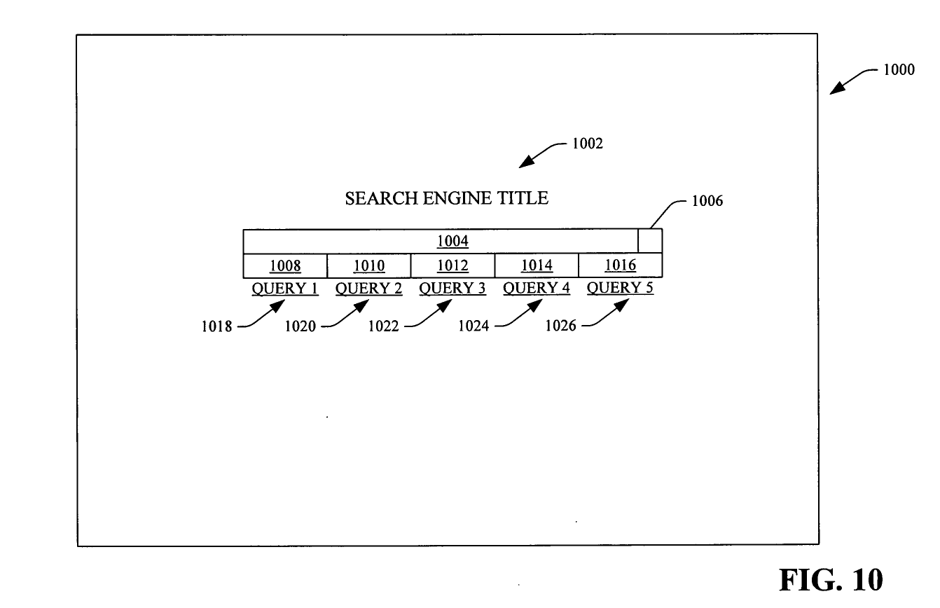

Referring collectively to FIGS. 10-12, example interfaces that depict presentation of informational items, such as queries, are presented. While such interfaces are shown as displaying a certain number of informational items in particular positions, it is understood that a number of informational items or position thereof can be different than what is shown in these figures while falling under the scope of the hereto-appended claims.

With reference now to FIG. 10, an example interface 1000 that depicts presentation of informational items to a user is illustrated. In this example, the presented informational items are queries. It is to be understood, however, that other informational items may be presented to the user. The interface 1000 includes a title area 1002 that can be used to present a title of a search engine to a user. The interface 1000 further includes a query field 1004, wherein a user can enter text into the query field. A search button 1006 can be selected to initiate a search using a query entered into the query field 1004. The interface 1000 may also include several buttons 1008, 1010, 1012, 1014, and 1016 that may be depressed by the user to further narrow a query. For instance, the button 1008, when depressed, may initiate a search for images using a query entered into the query field 1004, the button 1010 may initiate a search for videos using a query entered into the query field 1004, the button 1012 may initiate a search for current news using a query entered into the query field 1004, the button 1014 may initiate a search for map data using a query entered into the query field 1004, and the button 1016 may initiate a search for scholarly articles using a query entered into the query field 1004.

A plurality of queries 1018-1026 may also be presented to the user, wherein the queries are presented prior to the user entering text into the query field 1004. In an example, the queries may be predicted to be of interest to the user. In another example, search results corresponding to the queries may be predicted to be of interest to the user. The queries 1018-1026 may be presented as selectable hyperlinks, wherein selection of a query initiates a search using the query. For example, a user may use a point-and-click mechanism (e.g., a mouse, a pointing device and a touch screen, . . . ) to select the first query 1018, and the search engine can perform a search using the first query 1018. While the example interface 1000 is depicted as presenting five queries to the user, it is to be understood that more or fewer queries can be presented to the user.

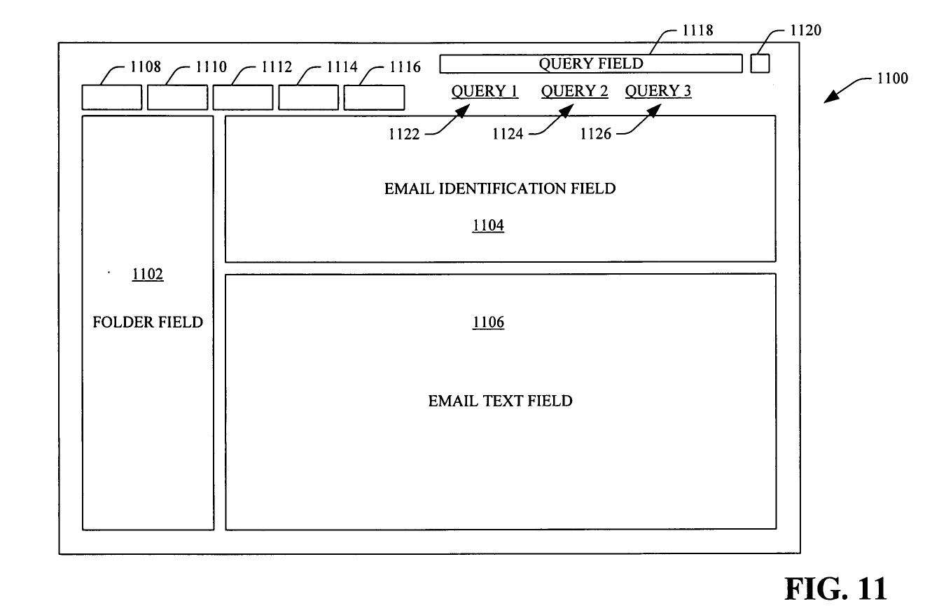

Turning now to FIG. 11, an example interface 1100 that depicts presentation of informational items to a user is illustrated. In this example interface 1100, the informational items are queries, although other informational items (such as direct hyperlinks to certain web pages) may be presented. The example interface 1100 is an email interface. The interface 1100 includes a folder field 1102 that includes selectable email folders. An email identification field 1104 displays, in short form, emails that are included in a selected folder. An email text field 1106 displays text of an email selected in the email identification field 1104. The interface 1100 further includes a plurality of depressible buttons that relate to email actions. For example, a first button 1108 when depressed may cause an address book to be presented to the user. A second button 1110 when depressed may cause a new email message to be generated. A third button 1112 when depressed may cause a selected email message to be forwarded. A fourth button 1114 when depressed may cause a selected email message to be subject to a reply. A fifth button 1116 when depressed may cause a selected email message to be deleted.

The interface 1100 may further include a query field 1118, wherein the user can enter a query into the query field 1118. A button 1120 can be depressed to initiate a search using the query (e.g., depressing the button 1120 causes a search engine to perform the search. In an example, a new browser window can be presented to the user upon depression of the button 1120, wherein the new browser window displays search results to the user. A plurality of queries 1122-1126 can also be presented to the user. The queries may be predicted to be of interest to the user, and can be provided in the form of selectable hyperlinks. Selection of one of the hyperlinks causes a search engine to perform a search for the query. The search results, for instance, may be presented to the user in a new browser window. In this example, three queries are displayed—it is to be understood, however, that a greater or lesser number of queries may be displayed to the user.

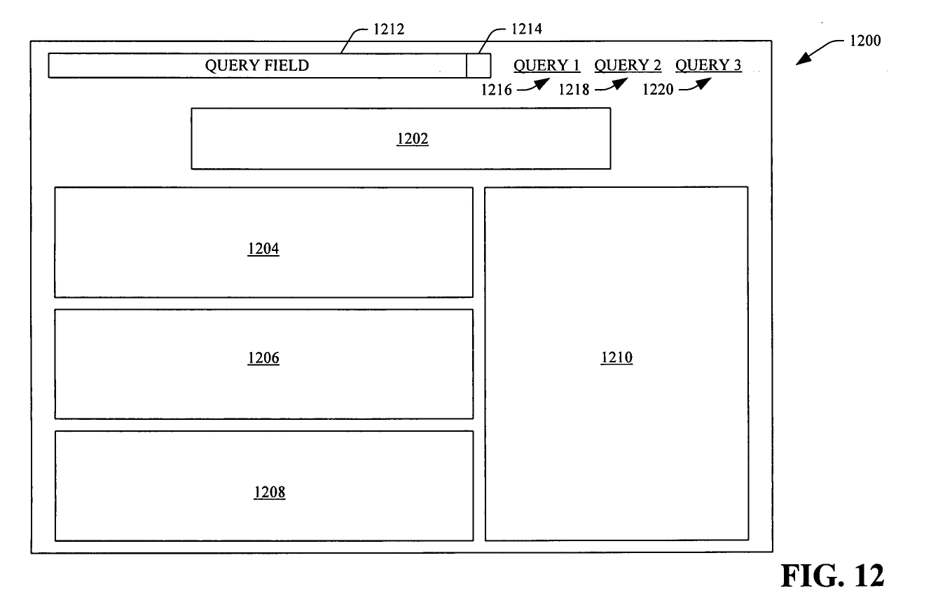

With reference now to FIG. 12, another example graphical user interface 1200 is illustrated. In this example interface 1200, presented informational items are queries, although other informational items may be presented on the interface 1200. The interface 1200, for instance, may be a news web page. The interface 1200 includes a title page 1202 that identifies a title of the news web page. The interface 1200 also includes three different sections 1204, 1206, and 1208 that present different news stories to the user. Furthermore, the interface includes a field 1210 that is used to present an image to the user, wherein the image may be related to one or more of the stories in the fields 1204-1208.

The interface further includes an interface to a search engine in the form of a query field 1212. As described above, the user can enter a query into the query field 1212 and depress a button 1214 to initiate a search for the query. Multiple queries 1216-1220 can be presented to the user, wherein the queries are presented prior to the user entering text into the query field 1212. As described above, the queries may correspond to a predicted informational interest of the user.

The example interfaces described herein are but a few of the several possible example interfaces where informational items that are predicted to be of interest to a user can be provided to such user. Other interfaces are contemplated and intended to fall under the scope of the hereto-appended claims.

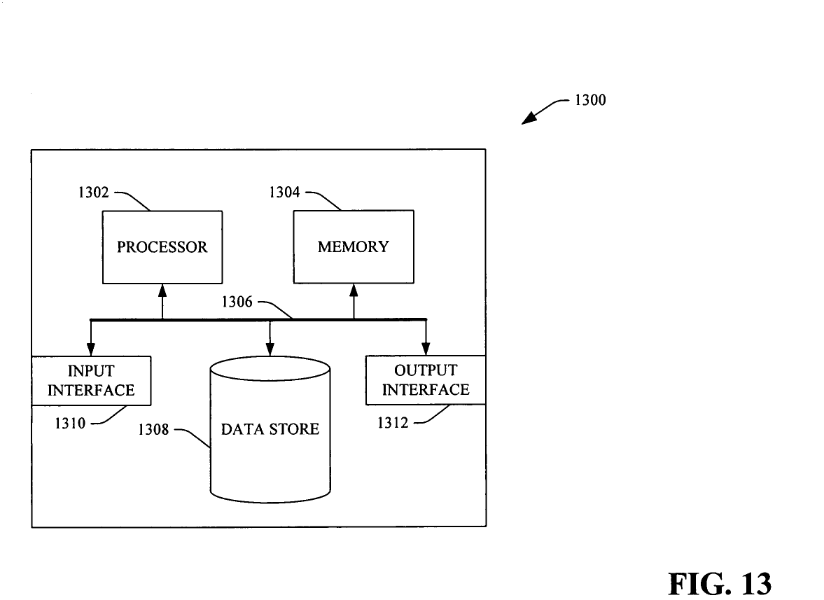

Now referring to FIG. 13, a high-level illustration of an example computing device 1300 that can be used in accordance with the systems and methodologies disclosed herein is illustrated. For instance, the computing device 1300 may be used in a search engine system. In another example, at least a portion of the computing device 1300 may be used in a portable device. The computing device 1300 may be a server, or may be employed in devices that are conventionally thought of as client devices, such as personal computers, personal digital assistants, and the like. The computing device 1300 includes at least one processor 1302 that executes instructions that are stored in a memory 1304. The instructions may be, for instance, instructions for implementing functionality described as being carried out by one or more components discussed above or instructions for implementing one or more of the methods described above. The processor 1302 may access the memory by way of a system bus 1306. In addition to storing executable instructions, the memory 1304 may also store queries, search results, etc.

The computing device 1300 additionally includes a data store 1308 that is accessible by the processor 1302 by way of the system bus 1306. The data store 1308 may include executable instructions, user history data, profile information, search results, labeled data, etc. The computing device 1300 also includes an input interface 1310 that allows external devices to communicate with the computing device 1300. For instance, the input interface 1310 may be used to receive an indication that a user wishes to initiate a search session. The computing device 1300 also includes an output interface 1312 that interfaces the computing device 1300 with one or more external devices. For example, the computing device 1300 may display informational items by way of the output interface 1312.

Additionally, while illustrated as a single system, it is to be understood that the computing device 1300 may be a distributed system. Thus, for instance, several devices may be in communication by way of a network connection and may collectively perform tasks described as being performed by the computing device 1300.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A computer-implemented system, comprising:
a receiver component that receives an indication that a user has accessed a search engine to initiate a search session; and
an analyzer component that predicts informational interests of the user upon receipt of the indication and outputs an informational item that corresponds to the predicted informational interests of the user, wherein the analyzer component is configured to output the informational item prior to the user issuing a query to the search engine.

2. The system of claim 1, wherein the informational item is a query.

3. The system of claim 2, wherein the analyzer component outputs multiple queries that are reflective of the informational interests of the user and assigns values to the multiple queries, wherein the values are indicative of a probability that the user is interested in information that is retrievable by way of the queries.

4. The system of claim 1, further comprising a display component that displays the informational item to the user on a homepage of the search engine.

5. The system of claim 4, wherein the informational item is displayed as a selectable hyperlink.

6. The system of claim 1, further comprising a training component that receives collected data and trains the analyzer component using the user history data.

7. The system of claim 1, wherein the analyzer component comprises:
a first predictor component that uses historical data of a plurality of users to predict the informational interests of the user;
a second predictor component that uses historical data of the user to predict the informational interests of the user; and
a third predictor component that uses historical data of a plurality of users that have a substantially similar profile of the user to predict the informational interests of the user, wherein the analyzer component uses predictions from the first predictor component, the second predictor component, and the third predictor component to output the informational item.

8. The system of claim 1, wherein the analyzer component predicts future informational interests of the user.

9. The system of claim 1, further comprising a query receiver component that receives a query from the user, wherein the analyzer component provides a query suggestion based at least in part upon the received query and predicted informational interests of the user.

10. The system of claim 1, wherein the search engine is one of an Internet search engine, a desktop search engine, and a database search tool.

11. The system of claim 1, wherein the analyzer component includes a relational model.

12. The system of claim 1, further comprising:
an interface component that receives user input with respect to the search engine;
a data collector component that collects data pertaining to the received user input; and
a training component that trains the analyzer component based at least in part upon data collected by the data collector component.

13. The system of claim 1, wherein the output informational item pertains to informational interests of the user in the future, the system further comprising:
a storage component that stores the informational item and a time in the future that corresponds to the information interests of the user; and
a display component that displays the query at the time in the future.

14. A computer-implemented method, comprising:
receiving an indication that a user has initiated a search session using a search engine; and
displaying an informational item to the user prior to the user issuing a query to the search engine, wherein the informational item corresponds to predicted informational interests of the user.

15. The method of claim 14, wherein the informational item is a query, and further comprising:
receiving an indication that the query has been selected by the user; and
displaying search results that correspond to the selected query.

16. The method of claim 15, further comprising:
collecting data pertaining to selection of the query and corresponding search results; and
using the collected data to predict informational interests of the user.

17. The method of claim 14, wherein the displayed informational item is a selectable hyperlink.

18. The method of claim 14, further comprising displaying a plurality of informational items prior to the user issuing a query to the search engine.

19. The method of claim 14, wherein the search engine is an Internet search engine.

20. A computer-readable medium comprising instructions that, when executed by a processor, perform the following acts:
receiving an indication that a user desires to view a graphical user interface that includes a query field, wherein a query submitted by way of the query field initiates a search of indexed items over the Internet;
using a machine learned model to predict at least one informational interest of the user;
generating a query that corresponds to search results that pertain to the informational interest of the user; and
displaying the query to the user prior to the user submitting a query by way of the query field.
